(19) United States
(12) Patent Application Publication
(10) Pub. No.: US 2022/0070676 A1
(43) Pub. Date: Mar. 3, 2022

(54) Identifying and distance-measuring remote devices

(71) Applicant: Bright Cocoon BV, Amersfoort (NL)

(72) Inventor: J.L.R. (John) DE GRAAFF, Amersfoort (NL)

(73) Assignee: Bright Cocoon BV

(21) Appl. No.: 17/458,628

(22) Filed: Aug. 27, 2021

(30) Foreign Application Priority Data
Aug. 28, 2020 (NL) 2026366

(51) Int. Cl. H04W 12/63; H04L 9/30; H04L 9/32; H04W 12/06; H04W 12/037

(52) U.S. Cl. CPC H04W 12/63; H04L 9/3073; H04W 12/037; H04W 12/06; H04L 9/3247

(57) ABSTRACT

The invention provides for a device that allows real-time feedback to its carrier (person) about the proximity or distance to another person. This feedback could be a friendly tune or some alarm sound pattern, or a visible light source with some color and brightness pattern. A person could for instance alter his behavior by creating more distance from other persons during a pandemic or in other situations where physical distance is desired. The device according to the invention is colloquially referred to as a SOTAR device, being short for “Sound Transponder Rangefinder”.

### FIELD OF THE INVENTION

The invention relates to a device for identifying remote devices and/or measuring a physical distance to these devices.

### BACKGROUND OF THE INVENTION

With the recent COVID-Sars-19 global pandemic showing no signs of stopping, more and more people and societies are getting ready for the “society at a distance”, where observing a 1.5-meter distance is strongly recommended and sometimes even legally required.

For many people, keeping such a distance is hard without technological assistance. Many proposals have been made, but none so far have seen success in the market. The most popular solutions for distance measurement involve the well-known Bluetooth technology used on most modern smartphones, where the signal strength is converted into a measure of distance.

### SUMMARY OF THE INVENTION

The present invention seeks to improve on the prior art by using sound waves as a propagation medium, and a data modulation scheme to carry identification data, with the goal to measure the distance and proximity from one device to another device, each potentially carried by a person, while moving around in a public space. Specific further goals include individual ones or a combination of: high accuracy (at the centimeter level), a limited measurement range (at the 10 meter range), performance in real-time (in one embodiment, within one second) and a non-forgeable identification exchange mechanism. The primary goal is to allow the system to create “Proximity Reports” (PREP) where the distance between 2 persons (between 2 devices) at a certain moment (timestamp) with their respective identifiers, and in a certain location (geolocation coordinates from a associated smartphone or a GNSS/GPS enabled device) is recorded.

The present invention, in at least some embodiments, provides for a device that allows real-time feedback to its carrier (person) about the proximity or distance to another person. This feedback could be a friendly tune or some alarm sound pattern, or a visible light source with some color and brightness pattern. This feedback mechanism is outside the scope of this patent application but shows one of the uses of the device: a person could alter his behavior by creating more distance from other persons during a pandemic or in other situations where physical distance is desired. The device according to the invention is colloquially referred to as a SOTAR device, being short for “Sound Transponder Rangefinder”.

Another aspect of the invention provides for a device to automatically determine proximity with other SOTAR devices and log these proximity events in a Proximity Report (PREP). These PREPs can be transferred to an associated smartphone or computer or Computer Cloud system, with the purpose of sending a warning to SOTAR users in case they have had close proximity with another user that has since been diagnosed with a contagious diseases or virus, and therefor this warned person could be infected.

Instead of sound waves, other signaling methods would be Radio Waves and Light Waves, but both have inhibiting properties with regard to the defined requirements:

(a) Radio Wave Propagation (bound by the Speed of Light) requires a 30-picosecond time resolution to be able to resolve a 1 centimeter distance, which is obviously very hard (and expensive) to do in current electronics, and

(b) Light Wave Propagation requires Line-of-Sight paths: paths that are both unobstructed and direct (directional).

Note that a popular misconception is that Bluetooth, which uses Radio Wave Propagation, and which is built-in in most modern smartphones, is able to measure distance between devices with enough accuracy to determine 1 meter proximity, but that is incorrect, as the only viable method to determine the distance would be to use the received signal level (RSSI) of the Bluetooth signals and use this value to calculate the approximate distance. While measurement of RSSI and calculations with this are obviously possible, the accuracy is in the 1-meter range and above, rendering this method unfit for situation where “social distancing” of 1 or 2 meters is required.

The invention further provides for a computer-readable storage medium comprising executable code for causing a computer to operate as the device of the invention.

According to at least some embodiments, there is provided a device for providing output regarding a distance of said device to a further device, said device comprising

means for, in an initial state, creating a unique public/private key pair that is used for authentication purposes with further devices, and for deriving an identifier from the public key of said public/private key pair,

means for, in a non-initial state, broadcasting an HELLO sound wave message, having the identifier and a sequence number encoded and modulated into the sent HELLO sound wave message,

means for receiving a further sound wave message from the further device, said message having a further identifier and a further sequence number being encoded and modulated into the received sound wave messages,

means for classifying the received further sound wave message as being one of a REPLY sound wave message and a HELLO sound wave message based on a presence or absence of said identifier from the sent HELLO sound wave message in the received further sound wave messages,

means for, if the received further sound wave message is classified as a REPLY sound wave message, calculating a physical distance between the device and the further device from the received sound wave message and the sent HELLO sound wave message, where the sequence number of the sent HELLO sound wave message is identical to the further sequence number of the received sound wave message,

means for, if the received further sound wave message is classified as a HELLO sound wave message, broadcasting a yet further REPLY sound wave message that has encoded the identifier of the device and the further sequence number in the yet further REPLY sound wave message, and

means for providing an output indicative of the calculated physical distance from said device to the further device.

Optionally the output is a human-perceptible output.

Optionally the output is one of: a musical tune, an alarm sound pattern, a visible light source with a color pattern, and a visible light source with a brightness pattern.

Optionally the output is a message appended to a logbook in a cryptographically secure fashion.

Optionally the means for classifying the received further sound wave message is configured to ignore the received further sound wave message if the further identifier cannot be used to verify a digital signature embedded in the received further sound wave message.

Optionally the device is implemented through a chip installed in, or software operated by, a personal device selected from the group consisting of a personal computer, tablet, smartphone, smart watch, wearable and other person-carried device.

Optionally said personal device comprises a processor and a memory, wherein a plurality of instructions are stored on said memory and are executed by said processor, wherein said instructions comprise instructions for performing:

in an initial state, creating a unique public/private key pair that is used for authentication purposes with further devices,

deriving an identifier from the public key of said public/private key pair,

in a non-initial state, broadcasting an HELLO sound wave message, having the identifier and a sequence number encoded and modulated into the sent HELLO sound wave message,

receiving a further sound wave message from the further device, said message having a further identifier and a further sequence number being encoded and modulated into the received sound wave messages,

classifying the received further sound wave message as being one of a REPLY sound wave message and a HELLO sound wave message based on a presence or absence of said identifier from the sent HELLO sound wave message in the received further sound wave messages,

if the received further sound wave message is classified as a REPLY sound wave message, calculating a physical distance between the device and the further device from the received sound wave message and the sent HELLO sound wave message, where the sequence number of the sent HELLO sound wave message is identical to the further sequence number of the received sound wave message,

if the received further sound wave message is classified as a HELLO sound wave message, broadcasting a yet further REPLY sound wave message that has encoded the identifier of the device and the further sequence number in the yet further REPLY sound wave message, and

providing an output indicative of the calculated physical distance from said device to the further device.

According to at least some embodiments, there is provided a non-transitory computer-readable medium storing a computer program including instructions that, when executed by a processor, causes an information processing apparatus to operate as the device as described herein.

According to at least some embodiments, there is provided a system for providing output regarding a measured distance, said system comprising:

a plurality of personal devices, wherein each personal device comprises a processor and a memory, wherein said memory stores instructions for execution by said processor; and

a communication network for communication between said plurality of personal devices;

wherein upon execution by said processor of each personal device, said instructions are capable of:

in an initial state, creating a unique public/private key pair that is used for authentication purposes between said plurality of personal devices,

deriving an identifier from the public key of said public/private key pair,

in a non-initial state, broadcasting an HELLO sound wave message through said communication network, having the identifier and a sequence number encoded and modulated into the sent HELLO sound wave message,

receiving a further sound wave message by a first personal device from a second personal device through said communication network, said message having a further identifier and a further sequence number being encoded and modulated into the received sound wave messages,

classifying the received further sound wave message as being one of a REPLY sound wave message and a HELLO sound wave message based on a presence or absence of said identifier from the sent HELLO sound wave message in the received further sound wave messages,

if the received further sound wave message is classified as a REPLY sound wave message, calculating a physical distance between said first and second personal devices from the received sound wave message and the sent HELLO sound wave message, where the sequence number of the sent HELLO sound wave message is identical to the further sequence number of the received sound wave message,

if the received further sound wave message is classified as a HELLO sound wave message, broadcasting a yet further REPLY sound wave message through said communication network that has encoded the identifier of each personal device and the further sequence number in the yet further REPLY sound wave message, and

providing an output indicative of the calculated physical distance to each of said personal devices.

### BRIEF DESCRIPTION OF THE FIGURES

The invention will now be explained in more detail with reference to the figures, in which:

FIG. 1 schematically illustrates functional components and their relation in one embodiment of a SOTAR device;

FIG. 2 schematically illustrates two persons carrying respective devices according to the invention; and

FIG. 3 illustrates an example of message exchanges for three (3) devices (A, B and C) that are in-range of each other, and one (1) device (D) only in-range with one (1) device (C) and not in-range for the other devices.

In the figures, same reference numbers indicate same or similar features. In cases where plural identical features, objects or items are shown, reference numerals are provided only for a representative sample so as to not affect clarity of the figures.

### DETAILED DESCRIPTION OF CERTAIN EMBODIMENTS

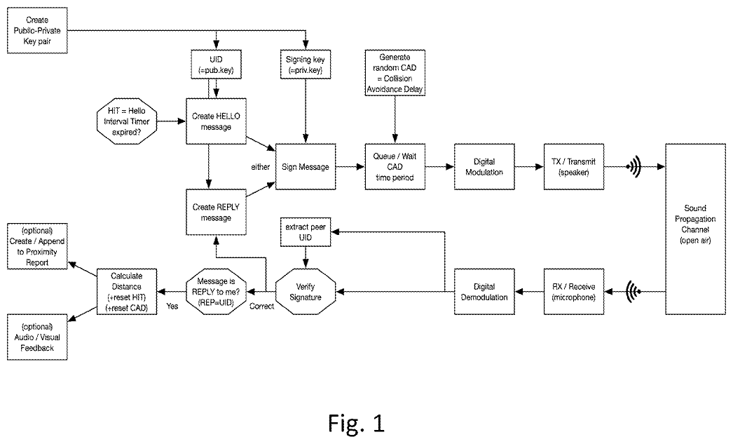

FIG. 1 schematically illustrates functional components and their relation in one embodiment of a SOTAR device. Such a device could be embodied as a special-purpose chip in and/or as software operated by e.g. a personal computer, tablet, smartphone, smart watch, wearable or other person-carried device, as a separate device or as software running on any device that has the requisite hardware capabilities, for example including a processor and a memory for storing instructions for execution by the processor. The SOTAR system could be used to help keep some distance between persons in a public space (social distancing). The SOTAR device could in that case be carried in or on clothing, provided as a wearable, smart watch, smartphone or other portable device.

In other applications, the device may be part of autonomous vehicles that need to keep a safe distance of one another, or of other devices and/or humans or animals.

In an initial state, the SOTAR Device creates a public/private key pair that is used for authentication purposes with other SOTAR devices, as will become apparent later. An important aspect of the SOTAR ranging method is that identifiers and messages and proximity reports are genuine and unforgeable.

For this end SOTAR uses a particular Public-Key Cryptography scheme that allows signing and verification of messages. For efficiency reasons, particularly to keep the message size as small as possible, and also to keep the message exchange number as low as possible, the Unique Identifier (UID) of a SOTAR device doubles as Public Key (PUB) and the corresponding Private Key (PRIV) is used to produce the Signature (SIG) that is to sign the Hash of the message.

This way the receiver of a SOTAR message can verify the integrity of the message by taking the UID as Public Key and verify the signature (SIG) to be both unaltered and the message to be validated as signed by the sender (using has Private Key PRIV).

As long as the device does not receive any (valid) messages, it will send HELLO messages every HIT time interval (there is no requirement for HIT, but 1 second may be preferable in practice). When a message is received and tested valid, the HIT timer and any CAD timer will be reset and a REPLY message is constructed, and queued for transmission.

Every message ready to be sent needs to wait a random number (CAD, Collision Avoidance Delay) of time periods (for example 10 milliseconds).

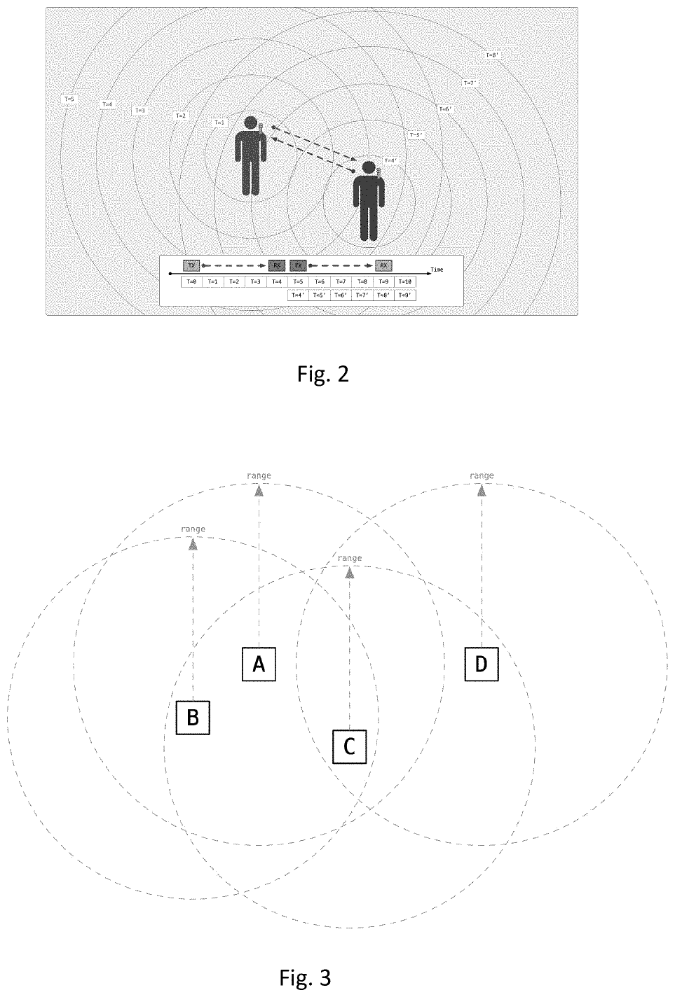

FIG. 2 schematically illustrates two persons carrying respective devices according to the invention (the objects on their left shoulders). This diagram shows two (2) persons moving around in a public space, each holding (wearing) an active SOTAR device. When the SOTAR devices send (sound) messages, these messages will propagate as waves in an outward circle pattern (equal speed in any direction). Both sent messages will be ‘heard’ and received by the other SOTAR device. Each SOTAR device can use the information in the received messages to identify the peer SOTAR device and to calculate the distance, by measuring the net one-way propagation time of the sound wave messages.

As the SOTAR system needs to determine the proximity and distance between any two devices within range, there needs to be an identification mechanism that uniquely identifies each device, and there needs to be point-to-point communications.

For this reason, the SOTAR system uses an “Active Transponder” mechanism, as opposed to a “Passive Reflection”, as is used in SONAR systems.

Active Transponder means that a message is sent by a device (say Device-A) in all directions equally (omnidirectional, with no specific destination specified) and that all devices that receive this message will respond with a new and different message and all of these new messages (one from every device in range) are too sent in all directions, and all these messages should be received by device A (assuming the sound medium as a communications channel is symmetrical, meaning the speed of sound and the attenuation is roughly equal in all directions), and when device A receives all of these messages (demodulates and decodes and find each unique identifier), it can identify each device, and calculate the distance to each of these devices in range.

To be able to distinguish all messages from all devices in range, each device needs an unique identifier (large number) and this identifier needs to be encoded and modulated into the sound signal.

Where data modulation is very common for Radio-wave and Light-wave communications, it is less common for (ultra) sound waves, and particularly so for omnidirectional sound systems.

Examples of omnidirectional Radio Wave communications systems are WiFi, Bluetooth, GPRS, 3G/4G/5G Mobile Radio Systems.

Examples of directional Sound Wave communications systems (also known as point-to-point systems) are the DTMF telephone key tone system, and telephone modem systems such as V.22bis 2400 bps modem, and V.90 56k6 bps modem.

For any omnidirectional communications system which shares a common propagation medium, there are 3 principal methods to access the shared medium: (1) Time Division Multiple Access or TDMA, (2) Frequency Division Multiple Access or FDMA, and (3) Code Division Multiple Access or CDMA, which is a form of Spread Spectrum system. For reason of implementation simplicity and cost, the SOTAR system uses TDMA for devices to access the shared medium.

Furthermore, the nature of the transmission medium (open air) calls for (a) asynchronous communications (no central clock signal) and for (b) half-duplex communications. The asynchronous requirement leads to the SOTAR messages needs to be prepended with synchronization information (like the Start-Of-Frame or SOF pattern of Ethernet and Wi-Fi systems), and the half-duplex requirement leads to the requirement of a Collision Avoidance system where the exact moment of transmission of SOTAR messages are controlled by a Collision-Avoidance (CA) mechanism, such as the CSMA/CA mechanism used in IEEE 802.11 WiFi systems.

The goal of communications within the SOTAR system is different than for normal communication systems, because there is no requirement for communications perse; the communications system in SOTAR is used to support the ranging function. SOTAR is primarily a navigation and positioning system.

Note that data communications or modulation is common for Radio Navigation systems, but quite new for Sound Navigation systems.

The minimal required number of messages for a SOTAR device, say Device-A, to measure the distance to an beforehand unknown, other SOTAR device that is in-range, say Device-B, is two (2) messages: HELLO and REPLY.

An exemplary message structure for HELLO would be

# msg-1 “HELLO from A” with the following fields:
VER = <version of the SOTAR protocol, integer number between 1 and
255>
SEQ = <sequentially progressive integer number of Device-A>
UID = <unique identifier of Device-A>
REP = <zero, not used in Hello>
CAD = <zero, not used in Hello>
SIG = <digital signature of this entire message>

An exemplary message structure for REPLY would be

# msg-2 “Hello from B, REPLY to A” with the following fields:
VER = <version of the SOTAR protocol, integer number between 1 and
255>
SEQ = <sequentially progressive integer number of Device-B>
UID = <unique identifier of Device-B>
REP = <reply-ID, ‘SIG’ from Hello-A msg, which captures A:UID and
A:SEQ>
CAD = <integer number as observed Collision Avoidance Delay>
SIG = <digital signature of this entire message>

All fields are binary numbers with a specific bit length, all of which are concatenated to form the binary coded message. The UID, REP and SIG fields have the same bit length.

In each message the identifier of the sender is encoded, and the message is signed with the senders private key. The signature (SIG field) serves both as verification, as for non-repudiation, as for a Message Integrity Check (to detect bit errors during transmission). This means that when there are some bit errors during transmission the received SIG will also not be valid, and the message is disregarded. Likewise, when there is an attempt to forge or manipulate the message, the SIG will not be valid, and the message is disregarded.

A major issue with the chosen Asynchronous Half-Duplex TDMA communications scheme is that potentially all devices are sending a REPLY message at the same time, resulting in collisions; when (minimum) two (2) transmissions occur at the same time in the same shared-medium, all messages cannot be received (demodulated and decoded) by any.

To overcome this problem, we propose two inter-depending methods: (a) a Collision Avoidance method, and (b) an Auto-Synchronization method.

First we allow the REPLY message from a SOTAR device to also function as a HELLO message for other devices. The REPLY message (from Device-B) is also received by the target device (Device-A which sent the original HELLO), and for this target device this message is both (1) a REPLY response to be used for its calculation of the distance A>B, as (2) a HELLO message, to which it will answer with its own REPLY, which Device-B needs to calculate the distance B>A.

In summary, when we only consider two devices, both can calculate the distance and create a PREP Proximity Report using in total three (3) messages:

[HELLO-A] >> [REPLY-A] >> [REPLY-B]

The other consequence of this interleaved message method, is that it creates a ripple effect; the first device to successfully send (i.e. without collision) a HELLO message, its message also serves as a synchronization epoch for other devices. Other devices will wait for a random number of time periods (a time period is defined as a 10 millisecond duration, although this number is subject to further research). This Collision Avoidance Delay (CAD) number is sent back in the REPLY message, which the target-device (as referred to in the REP field of the message) needs to calculate the one-way propagation time, which produces the distance.

Note that each SOTAR device should reset its delay timer every time it receives a message from any device.

As all devices that receive the original HELLO message will wait some random number of CAD delay periods, each will then send a REPLY message, and each of those REPLY messages doubles as a HELLO message, for potentially other devices that were not in range for the original HELLO message. This clearly shows the Auto-Synchronization method, and this also shows the Collision Avoidance method.

FIG. 3 illustrates an example of message exchanges for three (3) devices (A, B and C) that are in-range of each other, and one (1) device (D) only in-range with one (1) device (C) and not in-range for the other devices. In a preferred embodiment, the following messages would be exchanged:

TIME: [Sender] ==>{Message,reference:TIME:}==>[Receiver]
(expected-response)

| | |
|---|---|
| 01: [ Dev-A ]==>{ Hello from A, no-reply | } ==>[ Dev-B ] |
| (B>A:01=:02) | |
| [ Dev-A ]==>{ Hello from A, no-reply | } ==>[ Dev-C ] |
| (C>A:01=:03) | |
| 02: [ Dev-B ]==>{ Hello from B, Reply to A:01: | } ==>[ Dev-A* ] |
| (A>B:02=:04) | |
| [ Dev-B ]==>{ Hello from B, Reply to A:01: | } ==>[ Dev-C ] |
| (C>B:02=:07) | |
| 03: [ Dev-C ]==>{ Hello from C, Reply to A:01: | } ==>[ Dev-A* ] |
| (A>C:03=:05) | |
| [ Dev-C ]==>{ Hello from C, Reply to A:01: | } ==>[ Dev-B ] |
| (B>C:03=:06) | |
| [ Dev-C ]==>{ Hello from C, Reply to A:01: | } ==>[ Dev-D ] |
| (D>C:03=:08) | |
| 04: [ Dev-A ]==>{ Hello from A, Reply to B:02: | } ==>[ Dev-B* ] (none) |
| [ Dev-A ]==>{ Hello from A, Reply to B:02: | } ==>[ Dev-C ] (none) |
| 05: [ Dev-A ]==>{ Hello from A, Reply to C:03: | } ==>[ Dev-B ] (none) |
| [ Dev-A ]==>{ Hello from A, Reply to C:03: | } ==>[ Dev-C* ] (none) |
| 06: [ Dev-B ]==>{ Hello from B, Reply to C:03: | } ==>[ Dev-A ] (none) |
| [ Dev-B ]==>{ Hello from B, Reply to C:03: | } ==>[ Dev-C* ] (none) |
| 07: [ Dev-C ]==>{ Hello from C, Reply to B:02: | } ==>[ Dev-A ] (none) |
| [ Dev-C ]==>{ Hello from C, Reply to B:02: | } ==>[ Dev-B* ] (none) |
| [ Dev-C ]==>{ Hello from C, Reply to B:02: | } ==>[ Dev-D ] (none) |
| 08: [ Dev-D ]==>{ Hello from D, Reply to C:03: | } ==>[ Dev-C* ] |
| (C>D:08=:09) | |
| 09: [ Dev-C ]==>{ Hello from C, Reply to D:08: | } ==>[ Dev-A ] (none) |
| [ Dev-C ]==>{ Hello from C, Reply to D:08: | } ==>[ Dev-B ] (none) |
| [ Dev-C ]==>{ Hello from C, Reply to D:08: | } ==>[ Dev-D* ] (none) |

In the above, * denotes that the HELLO-REPLY cycle is complete for this device.

A sample Proximity Report (PREP), here for Device-C as a result of the above encounters, could look like this:

```
{
  “type” : “prep”,
  “sotar-version” : 1,
  “my-uid” : “0x000000000C”,
  “peer-list” : [
    “0x000000000A” : {
      “prox-list” : [
        {
          “start-time” : “2020-08-26T12:25:43Z”,
          “stop-time” : “2020-08-26T12:35:43Z”,
          “mean-geoloc” : “52.15517,5.38720”,
          “min-distance” : “89”,
          “avg-distance” : “124”,
          “max-distance” : “602”
        }
      ]
    },
    “0x000000000B” : {
      “prox-list” : [
        {
          “start-time” : “2020-08-26T12:25:48Z”,
          “stop-time” : “2020-08-26T12:35:48Z”,
          “mean-geoloc” : “52.15517,5.38720”,
          “min-distance” : “99”,
          “avg-distance” : “134”,
          “max-distance” : “542”
        }
      ]
    },
    “0x000000000D” : {
      “prox-list” : [
        {
          “start-time” : “2020-08-26T12:26:43Z”,
          “stop-time” : “2020-08-26T12:36:43Z”,
          “mean-geoloc” : “52.15517,5.38720”,
          “min-distance” : “182”,
          “avg-distance” : “260”,
          “max-distance” : “893”
        }
      ]
    },
  ]
}
```

A preferred embodiment of the method executed inside a SOTAR device could be modeled with the following Lua computer code:

```
--# start:SOTAR-algorithm
--# functions:
function random_number_between_10_500_step_10 ( )
  return math.random (1, 50) * 10
end
function start_timer (timer)
  if timer.name == “CAD” then
    timer.duration = random_number_between_10_500_step_10 ( )
  end
  timer.status = “running”
  if timer.expired then
    event = { type = timer.name }
  end
end
function stop_timer (timer)
  timer.status = “stopped”
end
function push_to (queue, msg)
  start_timer (CAD)
end
function send_msg (msg)
  if queue.isEmpty then
    start_timer (HIT)
  end
end
function get_next_sequence ( )
  seq = seq + 1
  return seq
end
function create_signature (msg, key)
  hash = some_hash_function (msg)
  sig = some_signature_function (hash, key)
  return sig
end
function create_message (arg_table)
  type = arg_table.type
  rep = arg_table.rep
  cad = random_number_between_10_500_step_10 ( )
  --# 1 us resolution is enough; sound propagation at 340 m/s over 1
cm takes 30 us
  now = get_time_microseconds ( ) --# current time in microseconds
  seq = get_next_sequence ( )
  if type == “HELLO” then
    rep = 0 --# not used HELLO msg
    cad = 0 --# not used HELLO msg
  elseif type == “REPLY” then
    rep = rep
    cad = cad
  end
  msg = {
    ver = version_sotar,
    seq = seq,
    uid = keypair.pub,
    rep = rep,
    cad = cad,
    sig = 0 --# placeholder, filled in later
  }
  sig = create_signature (msg, keypair.priv)
  msg.sig = sig
  meta = {
    time = now,
    cad = cad,
    msg = msg
  }
  database.save_msg_meta (meta)
  return msg
end
function calculate_distance (rcvd_msg_meta, saved_msg_meta)
  propagation_time = rcvd_msg_meta.time - saved_msg_meta.time -
(rcvd_msg_meta.msg.cad * factor_cad_to_usec)
  distance = propagation_time / factor_speed_of_sound
  return distance
end
--# variables:
version_sotar = 1
hit_default = 1000 --# default HELLO every 1000 millisecs
factor_cad_to_usec = 1e3 --# CAD is between 10..500 millisecs, need
1e3 to calc usecs
factor_speed_of_sound = 340 --# in meters per second
seq = 1 --# start with sequence number 1 for first message
queue = { } --# start with empty message queue
keypair = { pub = “”, priv = “” } --# template crypto public-private
key pair
keypair = database.get_keypair ( )
if not keypair then
  keypair = database.generate_keypair ( )
end
event = nil --# start with no event
HIT = {name = “HIT”, duration = hit_default, status = “stopped”} --#
HELLO Interval Timer
CAD = { name = “CAD”, duration = 0, status = “stopped” } --# Collision
Avoidance Delay in millisecs
--#
function main ( )
  while true do --# repeat forever
    if event then
      if event.type == “HIT” then --# HIT timer expired, create HELLO
message
        msg = create_message ({type=“HELLO”})
        push_to (queue, msg)
      elseif event.type == “CAD” then --# CAD timer expired, send
queued message
        msg = pop_from (queue)
        send_msg (msg)
      elseif event.type == “MSG” then --# message recevied (after
demod+decode+verify)
        rcvd_msg = event.rcvd_msg
        now = get_time_microseconds ( )
        --# do we send a reply? (not if already replied within HIT
interval):
        time = database.find_peer (rcvd_msg.uid) --# last seen time in
usec of peer.uid
        if (not time) or ((now - time) > hit_default) then --# do
reply if not found (not seen before)
          msg = create_message ({type=“REPLY”, rep=rcvd_msg.sig})
          push_to (queue, msg)
          stop_timer (HIT)
        end
        --# save rcvd_msg to database:
        database.save_peer ({peer = rcvd_msg.uid, time = now})
        --# is msg reply on our hello-msg? :
        rcvd_msg_meta = {
          time = now,
          msg = rcvd_msg
        }
        saved_msg_meta = find_msg_meta ({ sig = rcvd_msg.rep }) --#
search meta in database of sent-msgs
        if saved_msg_meta then
          distance = calculate_distance (rcvd_msg_meta,
          saved_msg_meta)
          database.save_prep ({ --# prep = Proximity Report
            time = now,
            uid = rcvd_msg.uid,
            distance = distance
          })
        end
      end
    end
    wait_little( )
  end
end
start_timer (HIT)
main ( ) --# start the main loop
--# end:SOTAR-algorithm
```

The above provides a description of several useful embodiments that serve to illustrate and describe the invention. The description is not intended to be an exhaustive description of all possible ways in which the invention can be implemented or used. The skilled person will be able to think of many modifications and variations that still rely on the essential features of the invention as presented in the claims. In addition, well-known methods, procedures, components, and circuits have not been described in detail.

Some or all aspects of the invention may be implemented in a computer program product, i.e. a collection of computer program instructions stored on a computer readable storage device for execution by a computer. The instructions of the present invention may be in any interpretable or executable code mechanism, including but not limited to scripts, interpretable programs, dynamic link libraries (DLLs) or Java classes. The instructions can be provided as complete executable programs, as modifications to existing programs or extensions (“plugins”) for existing programs. Moreover, parts of the processing of the present invention may be distributed over multiple computers or processors for better performance, reliability, and/or cost.

Storage devices suitable for storing computer program instructions include all forms of non-volatile memory, including by way of example semiconductor memory devices, such as EPROM, EEPROM, and flash memory devices, magnetic disks such as the internal and external hard disk drives and removable disks, magneto-optical disks and CD-ROM disks. The computer program product can be distributed on such a storage device, or may be offered for download through HTTP, FTP or similar mechanism using a server connected to a network such as the Internet. Transmission of the computer program product by e-mail is of course also possible.

When constructing or interpreting the claims, any mention of reference signs shall not be regarded as a limitation of the claimed feature to the referenced feature or embodiment. The use of the word “comprising” in the claims does not exclude the presence of other features than claimed in a system, product or method implementing the invention. Any reference to a claim feature in the singular shall not exclude the presence of a plurality of this feature. The word “means” in a claim can refer to a single means or to plural means for providing the indicated function.

What is claimed is:

1. A device for providing output regarding a distance of said device to a further device, said device comprising
means for, in an initial state, creating a unique public/private key pair that is used for authentication purposes with further devices, and for deriving an identifier from the public key of said public/private key pair,
means for, in a non-initial state, broadcasting an HELLO sound wave message, having the identifier and a sequence number encoded and modulated into the sent HELLO sound wave message,
means for receiving a further sound wave message from the further device, said message having a further identifier and a further sequence number being encoded and modulated into the received sound wave messages,
means for classifying the received further sound wave message as being one of a REPLY sound wave message and a HELLO sound wave message based on a presence or absence of said identifier from the sent HELLO sound wave message in the received further sound wave messages,
means for, if the received further sound wave message is classified as a REPLY sound wave message, calculating a physical distance between the device and the further device from the received sound wave message and the sent HELLO sound wave message, where the sequence number of the sent HELLO sound wave message is identical to the further sequence number of the received sound wave message,
means for, if the received further sound wave message is classified as a HELLO sound wave message, broadcasting a yet further REPLY sound wave message that has encoded the identifier of the device and the further sequence number in the yet further REPLY sound wave message, and
means for providing an output indicative of the calculated physical distance from said device to the further device.

2. The device of claim 1, wherein the output is a human-perceptible output.

3. The device of claim 2, wherein the output is one of: a musical tune, an alarm sound pattern, a visible light source with a color pattern, and a visible light source with a brightness pattern.

4. The device of claim 1, wherein the output is a message appended to a logbook in a cryptographically secure fashion.

5. The device of claim 1, wherein the means for classifying the received further sound wave message is configured to ignore the received further sound wave message if the further identifier cannot be used to verify a digital signature embedded in the received further sound wave message.

6. The device of claim 1, implemented through a chip installed in, or software operated by, a personal device selected from the group consisting of a personal computer, tablet, smartphone, smart watch, wearable and other person-carried device.

7. The device of claim 6, wherein said personal device comprises a processor and a memory, wherein a plurality of instructions are stored on said memory and are executed by said processor, wherein said instructions comprise instructions for performing:
in an initial state, creating a unique public/private key pair that is used for authentication purposes with further devices,
deriving an identifier from the public key of said public/private key pair,
in a non-initial state, broadcasting an HELLO sound wave message, having the identifier and a sequence number encoded and modulated into the sent HELLO sound wave message,
receiving a further sound wave message from the further device, said message having a further identifier and a further sequence number being encoded and modulated into the received sound wave messages,
classifying the received further sound wave message as being one of a REPLY sound wave message and a HELLO sound wave message based on a presence or absence of said identifier from the sent HELLO sound wave message in the received further sound wave messages,
if the received further sound wave message is classified as a REPLY sound wave message, calculating a physical distance between the device and the further device from the received sound wave message and the sent HELLO sound wave message, where the sequence number of the sent HELLO sound wave message is identical to the further sequence number of the received sound wave message,
if the received further sound wave message is classified as a HELLO sound wave message, broadcasting a yet further REPLY sound wave message that has encoded the identifier of the device and the further sequence number in the yet further REPLY sound wave message, and
providing an output indicative of the calculated physical distance from said device to the further device.

8. A non-transitory computer-readable medium storing a computer program including instructions that, when executed by a processor, causes an information processing apparatus to operate as the device of claim 1.

9. A system for providing output regarding a measured distance, said system comprising:
a plurality of personal devices, wherein each personal device comprises a processor and a memory, wherein said memory stores instructions for execution by said processor; and
a communication network for communication between said plurality of personal devices;
wherein upon execution by said processor of each personal device, said instructions are capable of:
in an initial state, creating a unique public/private key pair that is used for authentication purposes between said plurality of personal devices,
deriving an identifier from the public key of said public/private key pair,
in a non-initial state, broadcasting an HELLO sound wave message through said communication network, having the identifier and a sequence number encoded and modulated into the sent HELLO sound wave message,
receiving a further sound wave message by a first personal device from a second personal device through said communication network, said message having a further identifier and a further sequence number being encoded and modulated into the received sound wave messages,
classifying the received further sound wave message as being one of a REPLY sound wave message and a HELLO sound wave message based on a presence or absence of said identifier from the sent HELLO sound wave message in the received further sound wave messages,
if the received further sound wave message is classified as a REPLY sound wave message, calculating a physical distance between said first and second personal devices from the received sound wave message and the sent HELLO sound wave message, where the sequence number of the sent HELLO sound wave message is identical to the further sequence number of the received sound wave message,
if the received further sound wave message is classified as a HELLO sound wave message, broadcasting a yet further REPLY sound wave message through said communication network that has encoded the identifier of each personal device and the further sequence number in the yet further REPLY sound wave message, and
providing an output indicative of the calculated physical distance to each of said personal devices.
